(19) United States
(12) Patent Application Publication
(10) Pub. No.: US 2007/0216964 A1
(43) Pub. Date: Sep. 20, 2007

(54) Image-scanning apparatus capable of cleaning dust therein

(76) Inventor: Ta-Yi Lee, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/420,486

(22) Filed: May 26, 2006

(30) Foreign Application Priority Data
Mar. 14, 2006 (TW) 095204201

(51) Int. Cl. H04N 1/04

(52) U.S. Cl. 358/474

(57) ABSTRACT

An image-scanning apparatus is disclosed. The image-scanning apparatus includes a casing, a transparent platform, a scanning module, and a cleaning module. The transparent platform is mounted on the casing and has a first surface and a second surface. The first surface of the transparent platform allows an object to be put thereon. The scanning module is set inside the casing for moving along the second surface of the transparent platform to scan the image of the object. The cleaning module is mounted on the scanning module for moving together with the scanning module along the second surface of the transparent platform to clean the second surface of the transparent platform.

### BACKGROUND OF THE INVENTION

1. Field of the Invention

The invention relates to image scanning, and more particularly, to an image-scanning apparatus that is capable of cleaning dust therein.

2. Description of the Prior Art

Image-scanning apparatuses, such as scanners, printers, and multi-function printers (MFPs), are a kind of electronic devices frequently used in homes and offices. Generally speaking, image-scanning apparatuses can be divided into two types: sheet-fed image-scanning apparatuses and flat-bed image-scanning apparatuses. Flat-bed image-scanning apparatuses are more popular than sheet-fed image-scanning apparatuses since flat-bed image-scanning apparatuses provided better scanning quality.

Generally speaking, an image-scanning apparatus usually comprises a casing, a transparent platform mounted on the casing, and a scanning module set inside the casing. The transparent platform has a first surface and a second surface. The first surface of the transparent platform allows a user to put an object to be scanned thereon. The scanning module, which is set inside the casing, moves along the second surface of the transparent platform. Through the transparent platform, the scanning module scans the image of the object while moving along the second surface of the transparent platform.

Since the first surface of the transparent platform is not enclosed inside the casing, the user can easily clean the first surface of the transparent platform on his/her own. On the other hand, the second surface of the transparent platform is enclosed inside the casing. To clean the second surface of the transparent platform, the casing must be disassembled beforehand. However, disassembling the casing is not an easy task for ordinary users. Besides, if the user disassembles the casing, more dust or other foreign objects might enter the inner space of the casing and contaminate the scanning module. The image scanning quality of the image-scanning apparatus is then deteriorated. In short, cleaning the second surface of the transparent platform, which is enclosed inside the casing, brings inconveniences and troubles to the user and maintainer of the image-scanning apparatus. Even worse, unnecessary cost (time or money) might be wasted in cleaning the second surface of the transparent platform.

### SUMMARY OF THE INVENTION

One of the objects of the invention is to provide an image-scanning apparatus capable of cleaning dust therein while performing scanning tasks.

An embodiment of the invention discloses an image-scanning apparatus. The image-scanning apparatus comprises a casing, a transparent platform, a scanning module, and a cleaning module. The transparent platform is mounted on the casing and has a first surface and a second surface. The first surface of the transparent platform allows an object to be put thereon. The scanning module is set inside the casing for moving along the second surface of the transparent platform to scan the image of the object. The cleaning module is mounted on the scanning module for moving together with the scanning module along the second surface of the transparent platform to clean the second surface of the transparent platform.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows an image-scanning apparatus according to an embodiment of the present invention.

### DETAILED DESCRIPTION

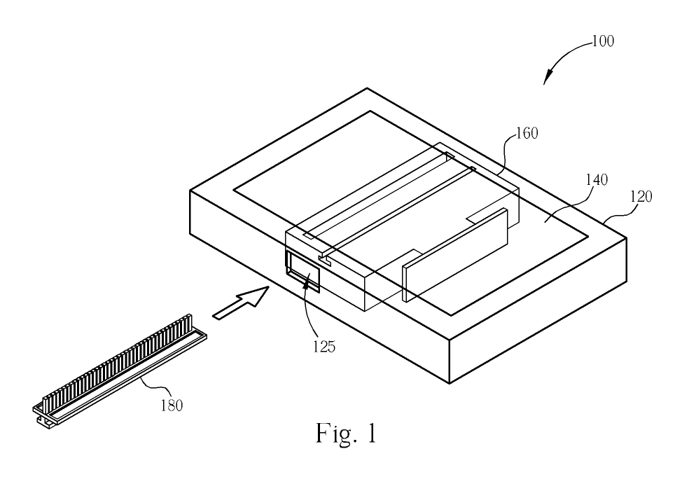

Please refer to FIG. 1, which shows an image-scanning apparatus according to an embodiment of the present invention. The image-scanning apparatus 100 shown in FIG. 1 is a flat-bed image-scanning apparatus, such as a flat-bed scanner, printer, or multi-function printer (MFP). Only the components that are relevant to the idea of the present invention are shown in FIG. 1, including a casing 120, a transparent platform 140, a scanning module 160, and a cleaning module 180. The transparent platform 140 is mounted on the casing 120 and has two surfaces, namely, a first surface and a second surface. The first surface of the transparent platform 140 allows the user to put an object to be scanned thereon. The scanning module 160 is set inside the casing 120 for moving along the second surface of the transparent platform 140 to scan the image of the object through the transparent platform 140.

In the embodiment shown in FIG. 1, the casing 120 further comprises an opening 125 on one side. Without disassembling the casing 120, the opening 125 allows the user to open it and slide the cleaning module 180 onto or out from the scanning module 160 through the opened opening 125. After the user slide the cleaning module 180 onto the scanning module 160, the cleaning module 180 can move together with the scanning module 160. In other words, when the image-scanning apparatus 100 is performing a scanning task, the cleaning module 180 together with the scanning module 160 move along the second surface of the transparent platform 140. Dust and other kinds of foreign objects on the second surface of the transparent platform 140 are therefore cleared out by the cleaning module 180 while the cleaning module 180 is moving along the second surface of the transparent platform 140. Aside from the above-mentioned dismountable relationship between the cleaning module 180 and the scanning module 160, in other embodiments the cleaning module 180 can also be fixedly combined with the scanning module 160 and the casing 120 does not have to include the opening 125.

In this embodiment, the cleaning module 180 comprises a dust-cleaning brush, which brushes dust off the second surface of the transparent platform 140. Exemplary materials that can be used to produce the dust-cleaning brush comprise feather and rubber. Through manual control or electrical control, the dust-cleaning brush can be adjusted to a position touching the second surface of the transparent platform 140. The dust-cleaning brush can also be made up of conducting material, so that the electrostatic charges on the transparent platform 140 will be discharged by the dust-cleaning brush and dust will then be less likely attracted and adhered by the second surface of the transparent platform 140. In addition, the cleaning module 180 can further comprise one or two dust-collecting troughs beside the dust-cleaning brush. Dust and foreign objects brushed off by the dust-cleaning brush will fall into the dust-collecting trough(s). With the opening 125 on the casing 120, the user does not have to disassemble the casing 120 to clean the dust-collecting trough(s). The user only has to open the opening 125, take the cleaning module 180 out from the scanning module 160 through the opening 125, clean the dust-collecting trough(s), put the cleaning module 180 back onto the scanning module 160 through the opening 125, and then close the opening 125.

In this embodiment, the cleaning module 180 cleans the second surface of the transparent platform 140 through physical contact. In other embodiments, even without physical contact, it is still possible for the cleaning module 180 to clean the second surface of the transparent platform 140. For one example, the cleaning module 180 may comprises a vacuum-cleaning unit that draws in dust or foreign objects from the second surface of the transparent platform 140 in a way similar to a vacuum cleaner. For another example, the cleaning module 180 may comprises an electrostatic precipitator that draws in dust or foreign objects from the second surface of the transparent platform 140.

Since the cleaning module 180 is combined with and moving together with the scanning module 160, when performing a scanning task, the cleaning module 180 can clean the second surface of the transparent platform 140 in the meantime. Besides, since the user does not have to disassemble the casing 120, the scanning module 160 will not be contaminated by the dust and foreign objects intruded while the casing 120 is temporally disassembled.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image-scanning apparatus, comprising:
a casing;
a transparent platform, mounted on the casing, the transparent platform having a first surface and a second surface, the first surface allowing an object to be put thereon;
a scanning module, set inside the casing, for moving along the second surface of the transparent platform to scan the image of the object; and
a cleaning module, mounted on the scanning module, for moving together with the scanning module along the second surface of the transparent platform to clean the second surface of the transparent platform.

2. The image-scanning apparatus of claim 1, wherein the cleaning module comprises:
a dust-cleaning brush, for brushing dust or foreign objects off the second surface of the transparent platform.

3. The image-scanning apparatus of claim 1, wherein the cleaning module comprises:
a vacuum-cleaning unit, for drawing in dust or foreign objects from the second surface of the transparent platform.

4. The image-scanning apparatus of claim 1, wherein the cleaning module comprises:
an electrostatic precipitator, for drawing in dust or foreign objects from the second surface of the transparent platform.

5. The image-scanning apparatus of claim 1, wherein the cleaning module comprises:
a dust-collecting trough, for collecting dust or foreign objects cleared out by the cleaning module.

6. The image-scanning apparatus of claim 1, wherein the casing comprises an opening which allows the whole or part of the cleaning module to be slide into or slide out from the scanning module.

7. The image-scanning apparatus of claim 1, wherein the image-scanning apparatus is a scanner, a printer, or a multi-function printer (MFP).

8. The image-scanning apparatus of claim 1, wherein the image-scanning apparatus is a flat-bad image-scanning apparatus.
